(19) United States
(12) Patent Application Publication
(10) Pub. No.: US 2014/0223179 A1
(43) Pub. Date: Aug. 7, 2014

(54) COMPUTER NETWORK SYSTEM FOR PREVENTING LOGGING OF INPUT DATA

(71) Applicant: Chi-Pei WANG, Hsinchu City (TW)

(72) Inventor: Chi-Pei WANG, Hsinchu City (TW)

(21) Appl. No.: 14/156,051

(22) Filed: Jan. 15, 2014

(30) Foreign Application Priority Data
Feb. 6, 2013 (TW) 102104652

(51) Int. Cl. G06F 21/60

(52) U.S. Cl. CPC G06F 21/602
USPC 713/168

(57) ABSTRACT

A computer network system for preventing logging of input data has a client side host computer and a data input and encryption device linked with the host computer for data transmission. The data input and encryption device is fitted with a data input interface for inputting textual data and also encrypting them for output. The data input and encryption device is provided with either of a self-encrypting keyboard, encryption mouse, encryption touch panel or realized by downloading applications via the smart communication device. A decryption server is linked via Internet with the host computer for data transmission and enables decryption of the textual output data after encryption by the data input and encryption device. An application server, linked via Internet or private network with the decryption server for data transmission, can receive the textual data input from the data input and encryption device after decryption by the decryption server.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to computer technology for preventing logging of input data, and more particularly to an innovative one which is designed to enable input encryption at the client side and remote decryption at the server.

2. Description of Related Art Including information Disclosed Under 37 CFR 1.97 and 37 CFR 1.98.

While the computer keyboard is used to transmit keying data to the host computer, the keying data are open and transparent due to open software/hardware specifications of PCs. In such a case, everyone can gain an access to the logging and hijacking software for the keying data of the clients via available software/hardware specifications or otherwise in other ways. With this characteristic, the computer logging or hijacking software could be utilized to illegally steal personal accounts and passwords.

Currently, computer clients are exposed to the extremely hazardous and complex interact environment wherein the computers are not loaded with encryption products, as evidenced in some cases such as the on-line game treasures or scores of computer players are often stolen, or some consumers have encountered money loss due to logging of their accounts and passwords in on-line banking. For these reasons, the banking convenience is restricted worldwide, e.g.: no RBM30,000 is allowed to be exceeded in cash transfer by non-specified, accounts, and on-line banking is even prohibited in some countries. Even if internet protocol encrypted with SSL (Secure Sockets Layer) or TLS (Transport Layer Security) is adopted, the input data are not protected, but may be stolen by the hijackers with encrypted interne protocol and sent back to their designated positions.

Some computer anti-logging products such as anti-logging keyboards, anti-logging software and connecting wires, have been developed for the benefit of the clients. However, some shortcomings and disadvantages are still observed, and on-line encryption is required in this aspect. According to a conventional anti-logging computer network system, the decryption position must be set onto the application server (e.g. server of internet bank), which should modify original webpages and servo programs in response to specific decryption setting processes, leading to higher configuration and management cost. Under such external pressure (e.g.: compulsory regulations), the internet banking operators find it difficult to establish safe functions of the computer network system for preventing logging of input data. Hence, on-line banking services are not safe enough, and clients are unwilling to conduct their business via on-line banking, resulting in poorer efficiency of on-line banking. On the other hand, common clients cannot identify and utilize more convenient on-line banking functions (the banks are apt to close some functions for lower business risks), e.g.: non-specified cash transfer (currently most banks require for cash transfer from specified accounts at the bank counter).

### BRIEF SUMMARY OF THE INVENTION

The computer network system of the present invention for preventing logging of input data is an innovative system mainly composed o f a client side host computer, a data input and encryption device, a decryption server and an application server. The present invention has the following advantages: as the textual data input from the client side are decrypted by the remote decryption server, rather than the client side host computer, the hijacking behavior could be prevented efficiently to realize anti-logging of input data, and it is possible to receive the encrypted textual data from the client side without need of modifying the design of the application server, thus reducing remarkably the setting and management cost.

Another objective of the present invention is to incorporate a smart communication device in the data input and encryption device that is provided with a data input interface permitting the clients to input textual data. In the preferred embodiment, the decryption server is linked via internet with the client side host computer for data transmission. Said decryption server enables remote data input into the client side host computer from the smart communication device. Data inputted from said smart communication device are equivalent to those from the client side computer (e.g. accounts and passwords). The hijackers cannot log onto the client side computer or gain an access to the Internet data between the host computer and the decryption server, since there is no direct correlation between the application programs of said smart communication device or tablet PC and said client side computer. Meanwhile, the biggest advantage lies in that the client is not required to purchase encryption hardware products such as an encryption keyboard and mouse, and encryption of data input is made possible only by downloading application programs, thus realizing better cost-saving and convenience.

### BRIEF DESCRIPTION OF THE SEVERAL VIEWS OF THE DRAWINGS

FIG. 1 is a schematic view of a preferred embodiment of the computer anti-logging system of the present invention.

FIG. 2 is a schematic view of another preferred embodiment of the computer anti-logging system of the present invention.

FIG. 3 is a schematic view of another preferred embodiment of the computer anti-logging system of the present invention.

### DETAILED DESCRIPTION OF THE INVENTION

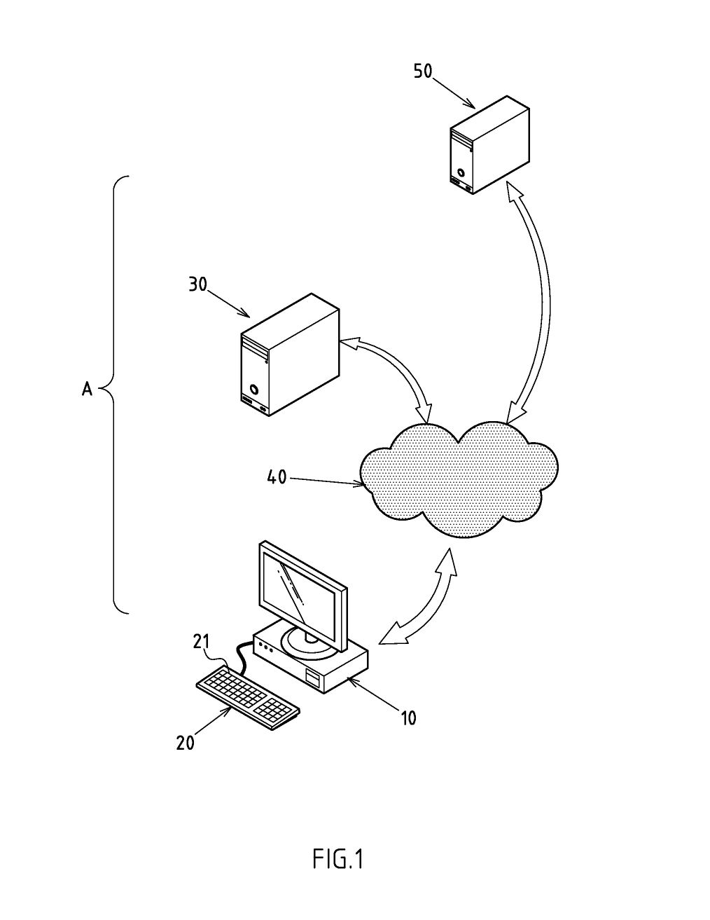

FIG. 1 depicts a preferred embodiment of a computer network system of the present invention for preventing logging of input data which, however, is provided fin only explanatory objective for patent claims.

Said computer anti-logging system A comprises at least a client side host computer 10 and a data input and encryption device 20 linked with the client side host computer 10 for data transmission. Said data input and encryption device 20 is provided with either of a self-encrypting keyboard, encryption mouse, encryption touch panel or an encryption on-screen keyboard (note: an encrypting keyboard shown in FIG. 1). Said data input and encryption device 20 is also fitted with a data input interface 21, permitting the clients to input textual data (e.g.: accounts or passwords) or output them after decryption.

A decryption server 30 is linked via Internet 40 with the client side host computer 10 for data transmission. Said decryption server 30 enables decryption of the textual output data after encryption by the data input and encryption device 20.

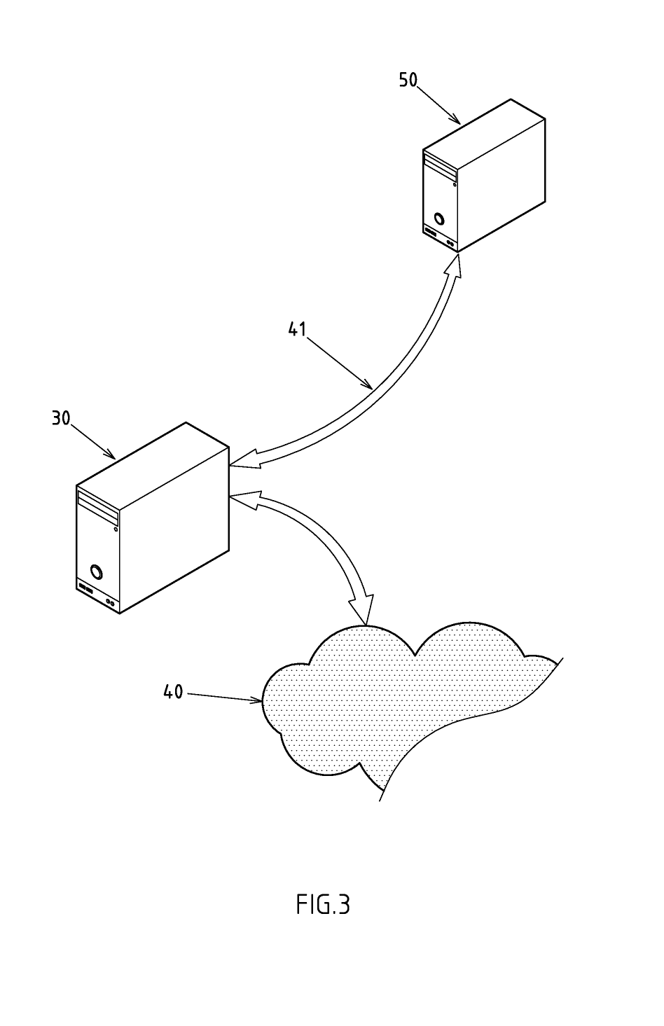

An application server 50 is linked via internet 40 or private network 41 (e.g. virtual private network, VPN, for higher safety as shown in FIG. 3) with the decryption server 30 for data transmission. Said application server 50 could receive the textual data input from the data input and encryption device 20 after decryption by the decryption server 30.

As the textual data input by the client are decrypted by the remote decryption server 30, rather than the client side host computer 10, the hijacking behavior could be prevented efficiently to realize anti-logging of input data, and it is possible to receive the encrypted textual data from the client side without need of modifying the design of the application server 50.

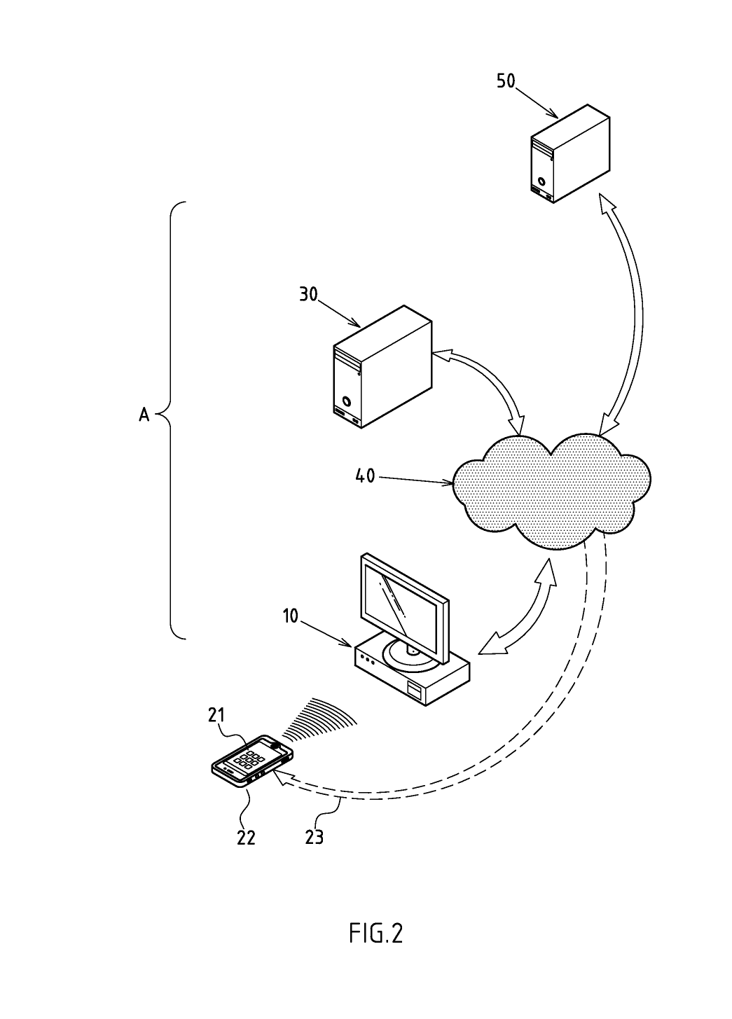

FIG. 2 depicts another preferred embodiment of the computer anti-logging system A of the present invention. Its main difference with prior art lies in that said data input and encryption device could also be replaced by a smart communication device 22, which is fitted with a data input interface 21 allowing the clients to input textual data. In this preferred embodiment, the decryption server 30 is linked via Internet 40 with the client side host computer 10 for data transmission. Also, the decryption server 30 enables remote data input into the client side host computer 10 through the smart communication device 22. The data input by the clients from the smart communication device 22 through the decryption server 30 are equivalent to the data input by the clients at the client side host computer 10 (e.g.: accounts, passwords). As the textual data input from the client side do not flow through the client side host computer 10, but directly flows into remote decryption server 30, this could prevent efficiently hijacking of textual data input by the client from the client side host computer 10 and network stream, namely, the hijacking software of the client side host computer 10 cannot gain an access to the input data by logging, since the data input by the smart communication device 22 are not directly associated with the client side host computer 10, helping to realize safe input of data (the same effect with encryption).

Of which, said smart communication device 22 comprises: a mobile phone (shown in FIG. 2) or tablet computer. Said application server 50 is employed for Internet banks, on-line shopping websites and on-line game websites, all of which require the clients to input the log-in data.

Of which, said smart communication device 22 allows to download a data input application 23, which is automatically connected with Internet and decryption server 30.

With above-specified, structural design, the core design of the computer anti-logging system A of the present invention lies in that said decryption server 30 is arranged between the client side host computer 10 (representing the client) and a specific application server 50 (representing the application side), namely, said decryption server 30 serves as an intermediary when the client side host computer 10 transmits textual data (e.g. accounts or passwords) to the application server 50. The textual data input by the client from the data input and encryption device 20 are encrypted and outputted, then decrypted at the decryption server 30, rather than at the client side host computer 10 or the application server 50. With this advantage, the hijackers cannot steal textual data input by the clients, because the hijackers may find it difficult to conduct hijacking from the decryption server 30 to the application server 50, thereby realizing optimum computer anti-logging of input data. On the other hand, for the administrators of the application server 50 (e.g.: Internet banks, on-line shopping websites and on-line game websites), since the encryption data input by the client have been decrypted in advance by the decryption server 30, the application server 50 permits data decryption without need of setting new software/hardware, nor modifying original webpages and servo programs in response to specific encryption/decryption stream for lower cost of configuration and management. Given the business opportunities and market competence therein, if said decryption server 30 is owned by a specific administrator, the administrator could seek for desired cooperation with numerous application administrators by virtue of aforementioned cost-saving advantages, and then strive to win benefits for all parties (the client could achieve data encryption, the administrator of decryption server 30 could win profits and the application administrator could save cost).

Referring also to FIG. 2, in view of the example wherein the data input device is replaced by the smart communication device 22, since the client is not obliged to purchase computer encryption products such as encrypting keyboard and encryption mouse, the smart communication device 22 could be changed into a data input device (e.g.: keyboard or mouse) by a downloading program (i.e.: data input application 23). Moreover, the data input application 23 is directly connected with the decryption server 30, rather than with the client site host computer 10. Through the decryption server 30, the client could input data from the client side host computer 10 by remote control of the data input application 23. Under such framework, the data input application 23 is not directly connected with the client side host computer 10, the data stream input by the client via the data input application 23 could pass through the decryption server 30 very safely (note: the data input application 23 could also encrypt the input data and then transmit to the decryption server 30 very safely without need of connecting firstly to the client side host computer 10), since the hijackers are not aware of the correlation between the data input application 23 and client side host computer 10). Decryption server 30 could decide if the decrypted input data are sent back to the client side host computer 10, e.g.: the accounts could be sent back to the client, but the passwords are not permitted to be sent back to the client side host computer 10, since the input passwords are only indicated by * (asterisk). According to another preferred embodiment, the data input application 23 is directly connected with the client side host computer 10, rather than with the decryption server 30, e.g.: the data input application 23, represented by Wifi keyboard of wireless mobile phone, allows to input data to the client side host computer 10 by on-line remote control. However, the data input application 23 has to encrypt properly the input data and then transmit to the client side host computer 10 for as lower risk of hijacking. But such framework is exposed to some inherent risks (data input application 23 is directly connected with the client side host computer 10). On the whole, the smart communication device 22 is taken as the safety source of the client's input data, helping to realize operational convenience in a cost-saving way.

1. A computer network system for preventing logging of input data; comprising:
a client side host computer;
a data input and encryption device, linked with the client side host computer for data transmission; said data input and encryption device is provided with either of a self-encrypting keyboard, encryption mouse encryption touch panel or an encryption on-screen keyboard; said data input and encryption device is also fitted with a data input interface, permitting the clients to input textual data or output them after decryption;
a decryption server, linked via Internet with the client side host computer for data transmission; said decryption server enables decryption of the textual output data after encryption by the data input and encryption device; and
an application server, linked is Internet or private network with the decryption server for data transmission; said application serer could receive the textual data input from the data input and encryption device after decryption by the decryption server;
as the textual data input by the client are decrypted by the remote decryption server, rather than the client side host computer, the hijacking behavior could be prevented efficiently to realize anti-logging of input data, and it is possible to receive the encrypted textual data from the client side without need of modifying the design of the application server.

2. The system defined in claim 1, wherein said smart communication device comprises: mobile phone and tablet computer; said application server is employed for Internet banks, on-line shopping websites and on-line game websites, all of which require the clients to input the log-in data.

3. A computer network system for preventing logging of input data; comprising:
a client side host computer;
a smart communication device, witch is fitted with a data input interface allowing the clients to input textual data;
a decryption server, linked via Internet with the client side host computer and smart communication device for data transmission; also, said decryption server enables remote data input into the client side host computer through the smart communication device; and
an application server, linked via Internet or private network with the decryption server for data transmission; said application server could receive the textual data input from the data input& encryption device after decryption by the decryption server;
as the textual data input from the client side do not flow through the client side host computer, but directly flow into remote decryption server, this could prevent efficiently hijacking of textual data input by the client from the client side host computer and network stream, the hijacking behavior could be prevented efficiently to realize anti-logging of input data, and it is possible to receive the encrypted textual data from the client side without need of modifying the design of the application server.

4. The system defined in claim 3, wherein said smart communication device comprises: mobile phone and tablet computer; said application server is employed for Internet banks, on-line shopping websites and on-line game websites, all of which require the clients to input the log-in data.

5. The system defined in claim 3, wherein said smart communication device allows to download a data input application, which is automatically connected with Internet and decryption server.
